(19) United States
(12) Patent Application Publication
(10) Pub. No.: US 2026/0073949 A1
(43) Pub. Date: Mar. 12, 2026

(54) INTER-COVER PLACEMENT OF ENVIRONMENT-CONTROLLING SUBSTANCES IN DATA STORAGE DEVICES

(71) Applicant: Western Digital Technologies, Inc., San Jose, CA (US)

(72) Inventors: Dongying LI, San Jose, CA (US); Miki NAMIHISA, Fujisawa-shi (JP); Gary LIU, San Jose, CA (US); Henry Chi Hang YIP, South San Francisco, CA (US); Yixiang ZHANG, San Jose, CA (US); Shin NAGAHIRO, Fujisawa-shi (JP); David DUDEK, San Jose, CA (US); Sukumar RAJAURIA, San Jose, CA (US); Qing DAI, San Jose, CA (US)

(73) Assignee: Western Digital Technologies, Inc., San Jose, CA (US)

(21) Appl. No.: 18/830,299

(22) Filed: Sep. 10, 2024

(51) Int. Cl. G11B 33/14

(52) U.S. Cl. CPC G11B 33/1453; G11B 33/1406

(57) ABSTRACT

A data storage device may include a sealed inner enclosure, wherein a gaseous environment inside of the sealed inner enclosure differs from a standard air environment; an outer cover situated over and coupled to at least a portion of the sealed inner enclosure; and an environment-controlling substance situated between the sealed inner enclosure and the outer cover. The sealed inner enclosure comprises at least one membrane to allow the environment-controlling substance to affect the gaseous environment inside of the sealed inner enclosure. A method of manufacturing a data storage device may comprise sealing an inner enclosure of the data storage device; applying an outer cover to the data storage device; including an environment-controlling substance between the inner enclosure and the outer cover; and creating a non-standard air environment within the inner enclosure of the data storage device.

### BACKGROUND

Data storage systems are used to store large amounts of information. A data storage system typically includes a read/write transducer for retrieving and storing information. Some data storage systems use rotating storage devices, such as rotating optical devices (e.g., compact disc (CD) and digital video (or versatile) disc (DVD) drives) or hard disk drives containing rotating magnetic disks (also referred to as platters or media). In some such data storage systems, a suspended slider supports a head that includes the read/write transducer. The slider provides mechanical support for the head and the electrical connections between the head and the rest of the data storage system.

When the data storage system is in operation, the slider floats a small distance above the recording medium (e.g., a hard disk in a hard disk drive), which rotates at high speeds. Components of the data storage system move the slider and, therefore, the head to a desired radial position over the surface of the rotating medium, and the head reads or writes information. The slider rides on a cushion or bearing of air or gas created above the surface of the medium as the disk rotates at its operating speed. The slider has an air-bearing surface (ABS) that faces the medium. The ABS is designed to generate an air-bearing force that counteracts a preload bias that pushes the slider toward the medium. The ABS causes the slider to fly above and out of contact with the medium.

Higher storage bit densities in magnetic media used in disk drives have reduced the size (volume) of data cells to the point where the cell dimensions are limited by the grain size of the magnetic material. Although grain size can be reduced further, the data stored within the cells may not be thermally stable. That is, random thermal fluctuations at ambient temperatures may be sufficient to erase data. This state is described as the superparamagnetic limit, which determines the maximum theoretical storage density for a given magnetic medium. This limit may be raised by increasing the coercivity of the magnetic medium or by lowering the temperature. Lowering the temperature may not always be practical when designing hard disk drives for commercial and consumer use. Raising the coercivity, on the other hand, may result in a need for write heads that incorporate higher magnetic moment materials, or techniques such as perpendicular recording (or both).

Another solution uses heat to lower the effective coercivity of a localized region on the magnetic media surface and writes data within this heated region. The data state becomes “fixed” upon cooling the media to ambient temperatures. This technique is broadly referred to as “thermally assisted (magnetic) recording” (TAR or TAMR), “energy assisted magnetic recording” (EAMR), or “heat-assisted magnetic recording” (HAMR). The term “HAMR” is used herein to refer to all of TAR, TAMR, EAMR, and HAMR.

In HAMR, a magnetic recording material with high magneto-crystalline anisotropy (Kᵤ) is heated locally during writing to lower the coercivity enough for writing to occur, but the coercivity/anisotropy is high enough that the recorded bits are thermally stable at the ambient temperature of the disk drive (i.e., the normal operating or “room” temperature of approximately 15-30 degrees Celsius). In some proposed HAMR systems, the magnetic recording material is heated to near or above its Curie temperature. The recorded data may then be read back at ambient temperature by a conventional magnetoresistive read head. HAMR disk drives have been proposed for both conventional continuous media, wherein the magnetic recording material is a continuous layer on the disk, and for bit-patterned media (BPM), in which the magnetic recording material is patterned into discrete data islands or “bits.”

One type of HAMR data storage device uses a laser source and an optical waveguide coupled to a near-field transducer (NFT) for heating the recording material on the media. A “near-field” transducer refers to “near-field optics,” wherein light is passed through a first element with subwavelength features and the light is coupled to a second element, such as a substrate (e.g., of a magnetic recording medium), located a subwavelength distance from the first element. The NFT is typically located at the air-bearing surface (ABS) of an air-bearing slider that also supports the read/write head and rides or “flies” above the media surface. An NFT may have a generally triangular output end, such that an evanescent wave generated at a surface of the waveguide couples to surface plasmons excited on the surface of the NFT, and a strong optical near-field is generated at the apex of the triangular output end.

One potential issue with HAMR devices is that excessive heating of the NFT can cause performance degradation and eventually failure of the data storage device. One possible cause of failure due to excessive heating may be due to adsorption of carbonaceous material on the slider overcoat near the NFT tip.

Hydrocarbon molecules from the recording media overcoat and lubricant can become mobile at elevated temperatures and adsorb on the ABS of the slider. Over time, these molecules can form a “smear” that absorbs power from the laser source and causes the NFT, which normally operates at very high temperatures, to become even hotter than usual. The heat transfer can result in diffusion of the NFT metal until the NFT tip rounds and recording degrades, eventually possibly leading to failure of the data storage device.

Smear can contain materials such as carbon, silicon, and/or nitrogen.

Consequently, if the smear is hot enough while in the presence of enough oxygen, it can oxidize and produce glassy products (e.g., materials that have amorphous, non-crystalline structures similar to that of glass, such as, e.g., SiO₂) and/or carbon-based gases (CO, CO₂, etc.), or combinations thereof. The produced gases dissipate, and the HAMR head's laser light can typically penetrate the resulting glassy products (if present) without heating them, which provides the desired heating of the recording media while preventing excessive heating of the NFT, which can substantially improve the lifetime of the NFT. This oxidation process consumes oxygen molecules inside of the data storage device.

Many older data storage devices operate in a standard air (e.g., nitrogen, oxygen, and water vapor mixture) atmosphere. Spinning recording media in hard disk drives at high revolutions per minute against the friction of an air atmosphere is relatively inefficient and requires a certain amount of power. To address this inefficiency, a data storage device can be filled at least partially with a lower-density gas, such as helium or hydrogen, and sealed to control and maintain the internal environment of the data storage device. Sealing mitigates or prevents leakage of internal gases from within the data storage device. The use of helium, which has a density that is approximately one-seventh that of air, reduces friction and vibration in the data storage device, thereby creating less drag and turbulence. Consequently, by running the data storage device in a less-dense atmosphere, such as an atmosphere of helium or a mixture of helium and oxygen, friction on the recording media is reduced, thereby causing the recording media to require less power in order to spin at a similar rate as the recording media in data storage devices that operate in standard air conditions. The use of helium generally also reduces the operating temperature of the data storage device, as well as the amount of noise it generates.

Smear is common in data storage devices that are sealed and contain helium, because there are far fewer oxygen molecules in such devices than in standard-atmosphere data storage devices. One side-effect of the (desirable) oxidation of smear in a sealed data storage device is that it consumes oxygen molecules sealed within the interior of the data storage device, which reduces the number of oxygen molecules available for oxidation as the data storage device ages. In addition to the oxidation of smear, other components in data storage devices can consume oxygen via oxidation (platter surface oxidation, connector and/or interface oxidation, printed circuit board (PCB) oxidation, head and/or actuator oxidation, etc.). As a result, the quantity of oxygen molecules available may eventually be insufficient to promote oxidation of the smear, which can cause the data storage device to fail. The loss rate of oxygen also tends to be exacerbated as the temperature of the data storage device increases.

It is also desirable to control other aspects of the environment within the data storage device. Manufacturers of data storage systems typically take steps to ensure that the internal components of hard drives are not adversely affected by humidity. For example, the materials used in the construction of hard disk drives may be selected for their resistance to humidity and corrosion to help protect the internal components from the effects of moisture. Hard disk drives are usually sealed in an airtight enclosure to prevent external contaminants, including moisture, from entering the drive. In addition, hard disk drives are generally assembled in controlled environments with regulated temperature and humidity levels to ensure that the drives are not exposed to excessive moisture during the manufacturing process. All of these practices are geared toward providing a stable head-disk interface, so that sliders can fly stably above the medium during its life. Thus, it can be helpful to be able to absorb excess water vapor to control the humidity.

Therefore, there is a need for improvements.

### SUMMARY

This summary represents non-limiting embodiments of the disclosure.

In some aspects, the techniques described herein relate to a data storage device, including: a sealed inner enclosure, wherein a gaseous environment inside of the sealed inner enclosure differs from a standard air environment; an outer cover situated over and coupled to at least a portion of the sealed inner enclosure; and an environment-controlling substance situated between the sealed inner enclosure and the outer cover, wherein the sealed inner enclosure includes at least one membrane to allow the environment-controlling substance to affect the gaseous environment inside of the sealed inner enclosure.

In some aspects, the environment-controlling substance includes a gas-releasing substance configured to release a gas. In some aspects, the gas-releasing substance includes a metal-organic framework (MOF) or a chemical compound. In some aspects, the gas-releasing substance includes at least one of: KMnO₄, KClO₃, MnO₂, AgMnO₄, 2Na₂CO₃·3H₂O₂, Na₂CO₃·1.5H₂O₂, Cu-BTC, or MIL 101 composite.

In some aspects, the environment-controlling substance includes a water-absorbing substance. In some aspects, the water-absorbing substance includes Zeolite or silica gel.

In some aspects, the environment-controlling substance is in a powder form, and the data storage device further includes a permeable container, wherein the environment-controlling substance is situated inside of the permeable container. In some aspects, at least a portion of the permeable container is malleable. In some aspects, the permeable container includes at least one of polyethylene (PE), polypropylene (PP), polyurethane (PU), ethylene vinyl acetate (EVA), polytetrafluoroethylene (PTFE), polyamide (PA), polyimide, polyvinyl alcohol (PVA), polyvinyl chloride (PVC), polyacrylonitrile (PAN), polyethylene terephthalate (PET), cellulose acetate, polysulfone (PSU), or polyvinylidene fluoride (PVDF).

In some aspects, the environment-controlling substance is included in: (a) a solid form situated in a volume of space between the sealed inner enclosure and the outer cover, or (b) a paste situated between the sealed inner enclosure and the outer cover.

In some aspects, a quantity of the environment-controlling substance is sufficient to release an amount of a gas expected to be consumed during a period of operation of the data storage device. In some aspects, the period of operation is a warranty period, an expected lifetime, or a specified number of hours.

In some aspects, a quantity of the environment-controlling substance is sufficient to absorb an expected amount of excess humidity during a period of operation of the data storage device. In some aspects, the period of operation is a warranty period, an expected lifetime, or a specified number of hours.

In some aspects, the techniques described herein relate to a method of manufacturing a data storage device, the method including: sealing an inner enclosure of the data storage device; applying an outer cover to the data storage device; including an environment-controlling substance between the inner enclosure of the data storage device and the outer cover of the data storage device; and creating a non-standard air environment within an interior of the inner enclosure of the data storage device.

In some aspects, including the environment-controlling substance between the inner enclosure of the data storage device and the outer cover includes situating a permeable container between the inner enclosure of the data storage device and the outer cover, wherein the permeable container contains the environment-controlling substance. In some aspects, at least a portion of the permeable container is malleable. In some aspects, the permeable container includes at least one of polydimethylsiloxane (PDMS), polyethylene (PE), polypropylene (PP), polyurethane (PU), ethylene vinyl acetate (EVA), polytetrafluoroethylene (PTFE), silicone rubber, cellulose acetate, polysulfone (PSU), or polyvinylidene fluoride (PVDF).

In some aspects, including the environment-controlling substance between the inner enclosure of the data storage device and the outer cover includes applying a paste between the inner enclosure of the data storage device and the outer cover, wherein the paste includes the environment-controlling substance.

In some aspects, including the environment-controlling substance between the inner enclosure of the data storage device and the outer cover includes situating a solid form between the inner enclosure of the data storage device and the outer cover, wherein the solid form includes the environment-controlling substance.

In some aspects, including the environment-controlling substance between the inner enclosure of the data storage device and the outer cover includes placing a container, a paste, or a solid form containing the environment-controlling substance in contact with the inner enclosure of the data storage device, and applying the outer cover to the data storage device includes attaching the outer cover to the inner enclosure of the data storage device after placing the container, the paste, or the solid form containing the environment-controlling substance in contact with the inner enclosure of the data storage device.

In some aspects, the environment-controlling substance includes a metal-organic framework (MOF) or a chemical compound. In some aspects, the environment-controlling substance includes at least one of: KMnO₄, KClO₃, MnO₂, AgMnO₄, 2Na₂CO₃·3H₂O₂, Na₂CO₃·1.5H₂O₂, Cu-BTC, or MIL 101 composite.

In some aspects, the environment-controlling substance includes a water-absorbing substance. In some aspects, the water-absorbing substance includes Zeolite or silica gel.

In some aspects, creating the non-standard air environment within the interior of the inner enclosure of the data storage device occurs after applying the outer cover to the data storage device.

In some aspects, the techniques described herein relate to a data storage device, including: a sealed inner enclosure, wherein a gaseous environment inside of the sealed inner enclosure differs from a standard air environment; an outer cover situated over and coupled to at least a portion of the sealed inner enclosure; and means for providing an environment-controlling substance between the sealed inner enclosure and the outer cover, wherein the sealed inner enclosure includes means for allowing the environment-controlling substance to affect the gaseous environment inside of the sealed inner enclosure.

### BRIEF DESCRIPTION OF THE DRAWINGS

Objects, features, and advantages of the disclosure will be readily apparent from the following description of certain embodiments taken in conjunction with the accompanying drawings in which:

FIG. 1 is a top view of an example of a data storage device into which embodiments disclosed herein can be incorporated.

FIG. 2 is a plot illustrating general trends of gas consumption by a sealed data storage device as it operates.

FIG. 3A is a representation of a sealed data storage device that includes a sealed inner enclosure and an outer cover in accordance with some embodiments.

FIG. 3B is a perspective view of an example of a sealed data storage device, showing the sealed inner enclosure with the outer cover in place over the sealed inner enclosure in accordance with some embodiments.

FIG. 3C is a closer perspective view of the sealed data storage device of FIG. 3B with a valve exposed.

FIG. 3D is a view of the sealed inner enclosure of the sealed data storage device in accordance with some embodiments.

FIG. 4A is a representation of a sealed data storage device that includes a sealed inner enclosure, an outer cover, and an environment-controlling substance in the gap between the inner cover of the sealed inner enclosure and the outer cover in accordance with some embodiments.

FIG. 4B is a representation of a permeable container that contains an environment-controlling substance in accordance with some embodiments.

FIG. 4C is an illustration of the example of a sealed inner enclosure with a permeable container that contains an environment-controlling substance situated in the recessed region of the inner cover in accordance with some embodiments.

FIG. 4D is a view of the underside of the inner cover of a sealed data storage device in accordance with some embodiments.

FIG. 5 is a flow diagram of a method of manufacturing a sealed data storage device in accordance with some embodiments.

FIG. 6A is a flow diagram of an example of a method of including an environment-controlling substance between a sealed inner enclosure and outer cover in accordance with some embodiments.

FIG. 6B is a flow diagram of an example of another method of including an environment-controlling substance between a sealed inner enclosure and outer cover in accordance with some embodiments.

FIG. 6C is a flow diagram of an example of another method of including an environment-controlling substance between a sealed inner enclosure and outer cover in accordance with some embodiments.

To facilitate understanding, identical reference numerals have been used, where possible, to designate identical elements that are common to the figures. It is contemplated that elements disclosed in one embodiment may be beneficially utilized in other embodiments without specific recitation. Moreover, the description of an element in the context of one drawing is applicable to other drawings illustrating that element.

### DETAILED DESCRIPTION

Disclosed herein are techniques to adjust the environment of a sealed data storage device using an environment-controlling substance situated between a sealed inner enclosure and an outer cover of the data storage device. The sealed inner enclosure houses various components of the data storage device that can provide benefits by being in a non-standard air environment (e.g., platters of a hard disk drive). The environment of the sealed inner enclosure may be controlled by the environment-controlling substance releasing a gas to compensate for the loss of a gas (e.g., oxygen) as the sealed data storage device (e.g., a hard disk drive) operates. Alternatively or in addition, the environment may be controlled by the environment-controlling substance absorbing a gas or vapor emitted from the sealed inner enclosure (e.g., water vapor) to adjust the humidity within the sealed inner enclosure. Multiple environment-controlling substances can be included in the data storage device as described herein (e.g., one environment-controlling substance can be provided to release oxygen, and another environment-controlling substance can be provided to absorb excess water).

Although this document presents the disclosures in the context of HAMR, it is to be appreciated that the techniques can be used in other applications. Similarly, although some of the disclosure is in the context of oxygen-releasing substances and/or water-absorbing materials, it is to be appreciated that the techniques can be used to release other gases instead or in addition, and/or to absorb other than water. In general, the disclosed techniques are applicable whenever it is desirable to increase the amount of a gas and/or decrease the amount of water in a controlled environment.

When the environment-controlling substance comprises a gas-releasing substance, the substance can release gas by a chemical reaction or heat (e.g., MnO₂, a permanganate (e.g., AgMnO₄, KMnO₄), a peroxide (e.g., H₂O₂, CaO₂, MgO₂), a perchlorate (e.g., KClO₃), a perborate (e.g., NaBO₃.H₂O), a persulfate (e.g., K₂S₂O₈), a percarbonate (e.g., 2Na₂CO₃·3H₂O₂, Na₂CO₃·1.5H₂O₂)). As another example, the environment-controlling substance can comprise, for example, a metal-organic framework (Cu-BTC, MIL 101 composite, etc.). As another example, the environment-controlling substance can comprise a high-pressure oxidizing gas. The environment-controlling substance releases gas over time, and the released gas can pass through a permeable membrane of the sealed inner enclosure into the interior of the sealed inner enclosure to replenish consumed gas (e.g., oxygen).

When the environment-controlling substance comprises an absorbing substance, it can comprise Zeolite, silica gel, or any other material that absorbs the desired gas or fluid (e.g., water vapor). The environment-controlling substance can absorb gas or fluid exiting the sealed inner enclosure.

The quantity and identity of the environment-controlling substance (e.g., which material or combination of materials, such as a specific compound, a specific MOF, etc., and how much of it to include in the data storage device) can be selected based on, for example, the rate of gas release or substance absorption the environment-controlling substance provides and/or the amount of the environment-controlling substance that would be needed to release a specified quantity of a particular gas (e.g., oxygen) or to absorb a specified amount of a gas or fluid (e.g., water vapor). For example, the identity and quantity of the environment-controlling substance can be selected based on the expected loss/consumption/release of a particular material (gas, vapor, fluid, etc.) within the data storage device during its lifetime. Thus, the identity (which material(s)) and/or quantity (how much of the material(s)) of the environment-controlling substance can be design parameters for the data storage device.

In some embodiments, the environment-controlling substance absorbs a gas or material (water, water vapor, etc.) emitted by the sealed inner enclosure.

In some embodiments, the environment-controlling substance releases gas, and the release of gas into the interior of the data storage device is temperature-dependent. In some embodiments, the environment-controlling substance releases gas whenever its temperature exceeds a threshold temperature. In some embodiments, the quantity of gas released and/or the rate of gas released per unit time by the environment-controlling substance increases as the temperature increases over the expected range of operating temperatures of the data storage device. As a result, by appropriate selection of the identity and quantity of the environment-controlling substance, the released gas can compensate substantially in real time for gas consumed by components of the data storage device.

The environment-controlling substance can be included in a container within the data storage device. The container can have or be made entirely of a permeable membrane or barrier (e.g., similar to an air filter) that allows gas to escape from the container and/or gas/vapor/liquid to enter the permeable container but prevents the environment-controlling substance itself from leaving the container. In some embodiments, the container is situated between the sealed interior enclosure and the outer cover of the data storage device.

The techniques disclosed herein are passive techniques, meaning that they provide autonomous gas compensation, as a matter of course and without intervention, as the data storage device operates. By matching the identity and quantity of the environment-controlling device to the expected gas consumption inside of the data storage device, passive techniques provide an elegant, cost-effective solution to compensate for gas consumption.

Some of the discussion herein is in the context of oxygen replenishment, but it is to be understood that the disclosures are not limited to compensating for oxygen consumption. In general, the described techniques can be used to replenish any gas or combination of gases. Similarly, although examples are provided of the environment-controlling substance absorbing water or water vapor to control humidity, it is to be appreciated that the same techniques can be used to absorb other substances (gas, liquid, vapor, etc.).

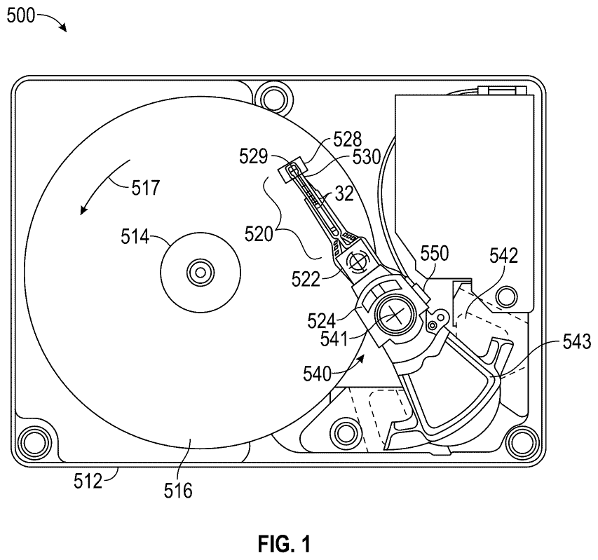

FIG. 1 is a top view of an example of a data storage device 500 (e.g., a HAMR data storage device or another type of data storage device) into which embodiments disclosed herein can be incorporated. FIG. 1 illustrates a head/disk assembly of the data storage device 500 with the cover removed. The data storage device 500 includes a rigid base 512 supporting a spindle 514 that supports a recording medium 516 (or multiple recording medium 516). The spindle 514 is rotated by a spindle motor, which, in operation, rotates the recording medium 516 in the direction shown by the curved arrow 517. The data storage device 500 has at least one load beam assembly 520 having an integrated lead suspension (ILS) or flexure 530 with an array 32 of electrically conductive interconnect traces or lines. The at least one load beam assembly 520 is attached to rigid arms 522 connected to an E-shaped support structure, sometimes called an E-block 524. The flexure 530 is attached to a slider 528, which is typically formed of a composite material, such as a composite of alumina/titanium-carbide (Al₂O₃/TiC).

A recording head 529 for recording to a recording medium 516 is located at the end or trailing surface of the slider 528. The recording head 529 comprises a read portion for reading from the recording medium 516 and a write portion for writing to the recording medium 516. FIG. 1 illustrates only one recording medium 516 surface with the slider 528 and recording head 529, but there may be multiple recording medium 516 stacked on a hub that is rotated by the spindle motor, with a separate slider 528 and recording head 529 associated with each surface of each recording medium 516.

As the recording medium 516 rotates, the recording medium 516 drags gas (which may be air, helium, etc.) under the slider 528 in a direction approximately parallel to the tangential velocity of the recording medium 516. The slider 528 has a media-facing air-bearing surface (ABS) that causes the slider 528 to ride on a cushion or bearing of gas, typically air, mostly helium, or hydrogen, generated by rotation of the recording medium 516. (It is to be understood that the term “air-bearing surface (ABS)” is used herein to refer to the gas-bearing surface of a slider, regardless of whether the gas within the drive is air or another gas (e.g., predominantly helium) or a mixture of gases.) As the air or gas passes under the slider 528 ABS, compression of the air or gas along the air flow path causes the air pressure between the recording medium 516 and the slider 528 to increase, which creates a hydrodynamic lifting force that counteracts the tendency of the at least one load beam assembly 520 to push the slider 528 toward the recording medium 516. The slider 528 thus flies above the recording medium 516 but in close proximity to the surface of the recording medium 516. The flexure 530 enables the slider 528 to “pitch” and “roll” on the air (or gas) bearing generated by the recording medium 516 as it rotates. Thus, during normal operation, the recording head 529 remains slightly above the surface of the recording medium 516, riding on the air bearing.

The data storage device 500 of FIG. 1 also includes a rotary actuator assembly 540 rotationally mounted to the rigid base 512 at a pivot point 541. The rotary actuator assembly 540 may include a voice coil motor (VCM) actuator that includes a magnet assembly 542 fixed to the rigid base 512 and a voice coil 543. The voice coil 543 is a coil of wire attached to the recording head 529 assembly. It is situated within the magnetic field of the magnet assembly 542. The voice coil 543 is mounted on the rotary actuator assembly 540. As the electric current varies in the voice coil 543, the resulting magnetic field interacts with the magnet assembly 542, causing a force that moves the entire rotary actuator assembly 540. The movement of the rotary actuator assembly 540 positions the recording head 529 over the desired data track on the recording medium 516.

When energized by control circuitry, which may include, for example, a processor, the voice coil 543 moves and thereby rotates E-block 524 with the rigid arms 522 and the at least one load beam assembly 520 to position the recording head 529 over the data tracks on the recording medium 516. As the recording medium 516 rotates in the direction of the curved arrow 517 shown in FIG. 1, the movement of the rotary actuator assembly 540 allows the recording head 529 on the slider 528 to access different data tracks on the recording medium 516. The process of moving the recording head 529 to the correct track is known as “seeking.”The array 32 of electrically conductive interconnect traces or lines connects at one end to the recording head 529 and at its other end to read/write circuitry contained in an electrical module or chip 550, which, in the data storage device 500 of FIG. 1, is secured to a side of the E-block 524. The chip 550 includes a read/write integrated circuit (R/W IC). The chip 550 may include a controller (e.g., as part of the R/W IC or external to it). The chip 550 may assist in the implementation of the techniques described herein.

To read information from the recording medium 516, the recording head 529 may include at least one read head or read sensor. The read sensor(s) in the recording head 529 may include, for example, one or more giant magnetoresistance (GMR) sensors, tunneling magnetoresistance (TMR) sensors, or another type of magnetoresistive sensor. When the slider 528 passes over a track on the recording medium 516, the recording head 529 (via the read head) detects changes in resistance due to magnetic field variations recorded on the recording medium 516, which represent the recorded bits.

To write information to the recording medium 516, the recording head 529 includes a write head (or write portion). In general, the write head can be any suitable write head. Some of the examples included herein describe and illustrate a HAMR head, but it is to be appreciated that the disclosed techniques are applicable to other types of recording head 529.

In operation, after the voice coil 543 has positioned the recording head 529 over the data tracks on the recording medium 516, the recording head 529 may be used to write information to one or more tracks on the surface of the recording medium 516 and to read previously-recorded information from the tracks on the surface of the recording medium 516. The tracks may comprise discrete data islands of magnetizable material (e.g., bit-patterned media), or the recording medium 516 may have a conventional continuous magnetic recording layer of magnetizable material. Processing circuitry in the data storage device 500 (e.g., on the chip 550) provides to the recording head 529 signals representing information to be written to the recording medium 516 and receives from the recording head 529 signals representing information read from the recording medium 516.

As explained above, smear can be a problem for data storage devices 500 (e.g., HAMR devices). As also explained above, oxygen molecules in a sealed data storage device 500 tend to be consumed (e.g., the amount of oxygen decreases) as the data storage device 500 ages, which can make smear more of a problem the longer the data storage device 500 is in operation. The rate of loss of oxygen is generally proportional to temperature.

What is needed are devices and techniques that allow additional oxygen to be introduced into a sealed data storage device 500 as it operates (e.g., to compensate for or replace oxygen lost/consumed as the data storage device 500 operates). Such techniques are described herein. Although the some of the discussion herein assumes that the gas lost/consumed during operation of the data storage device 500 is oxygen, it is to be appreciated that the disclosure is applicable to other gases or combinations of gases. Thus, generally speaking, some the disclosures herein concern the replenishment of gas (either a single gas or a mixture of gases) as a data storage device 500 (e.g., a sealed data storage device 500) operates/ages. In some embodiments, the replenishment is passive and occurs as a result of temperature changes inside of the data storage device 500. In some embodiments, the disclosed techniques replenish oxygen consumed by oxidation and/or other processes.

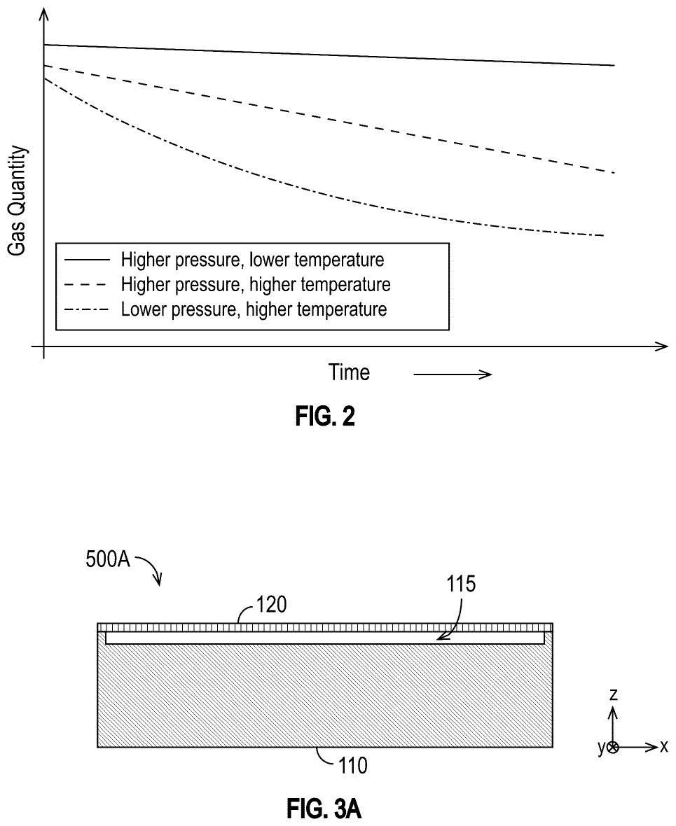

FIG. 2 is a plot illustrating general trends of gas consumption by a sealed data storage device 500 as it operates. The x-axis represents time, and the y-axis represents the amount of a gas (e.g., oxygen) in the data storage device 500 (e.g., in the sealed inner enclosure). The plot in FIG. 2 shows the effects over time of temperature and pressure on gas consumption, in particular to show the effects of higher and lower pressures and higher and lower temperatures. The solid curve represents the gas-consumption trend when the pressure inside the data storage device 500 is at a higher level, and the operating temperature is at a lower level. As shown, in a higher pressure, lower temperature condition, the amount of gas in the data storage device 500 decreases over time, but the consumption is relatively slow and consistent.

The dashed curve represents the trend when the pressure inside the data storage device 500 is at the higher level (same higher level as the solid curve), but the temperature is higher than for the solid curve. As shown, the effect of the higher temperature is that gas is consumed more rapidly than when the temperature is lower. Thus, FIG. 2 indicates that gas is consumed at a higher rate when the temperature is higher, even when the pressure remains constant.

The dash-dot curve in FIG. 2 shows the effect of lower pressure. The dash-dot curve represents the trend when the pressure inside the data storage device 500 is lower than for the solid or dashed curves, and the temperature is higher (same higher temperature as the dashed curve). Under these conditions, the rate of gas consumption is even higher. A comparison between the dashed and the dash-dot curves shows that the effect of the lower pressure is that more gas is consumed per unit time. In a sense, the dash-dot curve represents a worst-case scenario of lower pressure and higher temperature.

In addition to the loss of oxygen during operation, sealed data storage devices can suffer from degraded performance because of excess humidity. For example, due to the use of heat in HAMR, during write operations, various components in the data storage device 500 (the NFT itself, cladding material surrounding the NFT, etc.) can experience very high temperatures that can cause chemical reactions among materials in the recording components (e.g., the recording head 529) and/or atmosphere (e.g., the fill gas of a sealed data storage device) of the data storage device 500 and/or the recording medium 516. These reactions can generate contaminants in the interior of the data storage device 500, including water vapor/humidity that was absorbed on the surface of the recording medium 516. The water vapor can lead to performance degradation, reduced reliability, and/or reduced lifetime operability. As an example, cladding on and around the HAMR components of the recording head 529 can erode during write operations due to water being present on the recording medium 516 becoming steam, or water in the gas phase. Therefore, one way to mitigate cladding erosion is by reducing the relative humidity. Lower relative humidity results in less water on the recording medium 516 or in the gas phase, which reduces the likelihood of steam causing cladding erosion and thus increases the operational lifetime of the recording head 529. Accordingly, some the disclosures herein concern the lowering of humidity and/or absorption of water vapor as a data storage device 500 (e.g., a sealed data storage device 500) operates/ages. In some embodiments, the reduction of humidity is passive and occurs as a result of temperature changes inside of the data storage device 500.

Sealed helium disk drives, such as helium-filled hard drives, are a type of data storage device 500 designed to improve performance and efficiency by using helium gas inside the sealed drive enclosure instead of a standard air environment. Helium is less dense than air, which reduces turbulence and friction inside the data storage device, leading to lower power consumption, less heat generation, and the ability to use more platters within the same physical space.

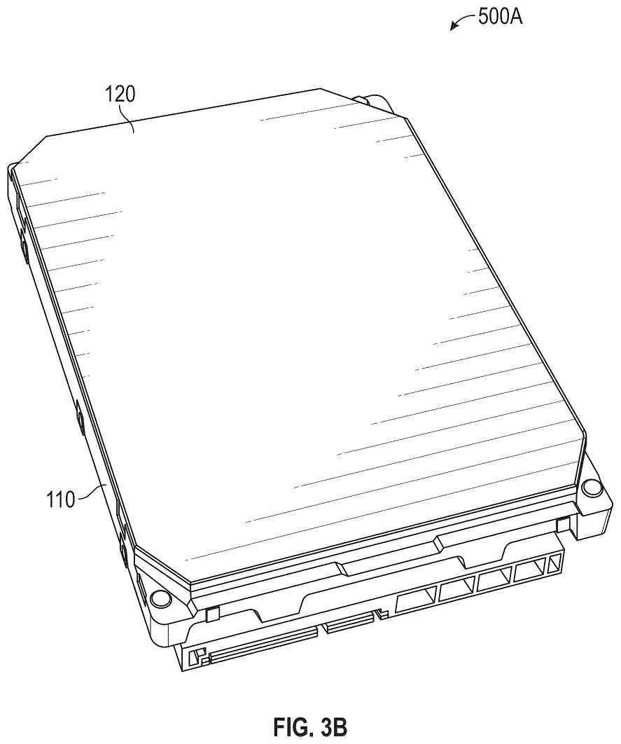

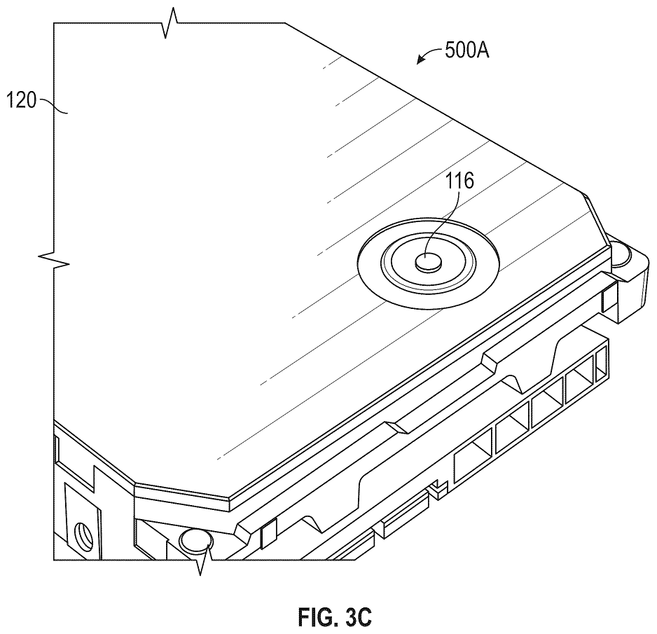

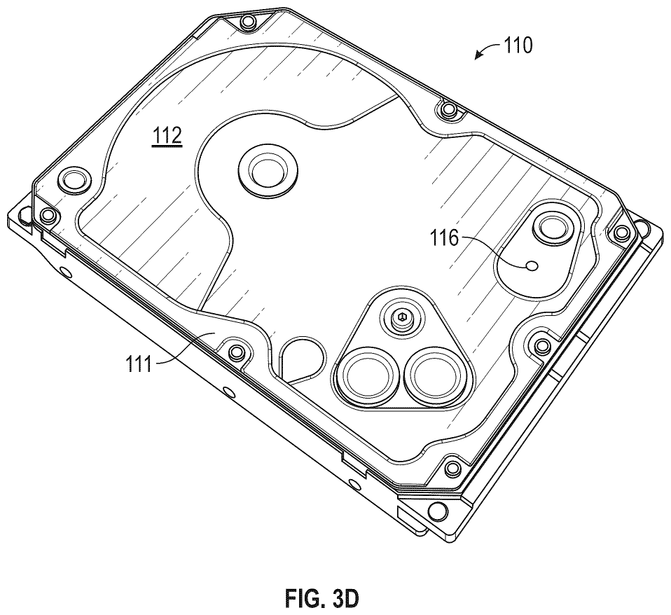

Some sealed data storage devices include a sealed inner enclosure and an outer cover. FIG. 3A is a representation of a sealed data storage device 500A that includes a sealed inner enclosure 110 and an outer cover 120. Also shown are coordinate axes with rectangular coordinates. The sealed inner enclosure 110 houses many of the components of the sealed data storage device 500A, such as, for example, the recording medium 516, the spindle 514, and other of the components discussed above and illustrated in FIG. 1. Between the sealed inner enclosure 110 and the outer cover 120 is a gap 115. The gap 115 may be small, such as a distance of less than 1 mm between the sealed inner enclosure 110 and the outer cover 120 (i.e., in the z-direction using the rectangular coordinate system shown in FIG. 3A). For example, the gap 115 between the sealed inner enclosure 110 and the outer cover 120 may be leave a distance of approximately 0.2 mm between the sealed inner enclosure 110 and the outer cover 120. The volume of space between the sealed inner enclosure 110 and the outer cover 120 may be, for example, less than 2 cm³. Although small, the gap 115 can be sufficient to hold a few grams of the environment-controlling substance.

FIG. 3B is a perspective view of an example of a sealed data storage device 500A, showing the sealed inner enclosure 110 with the outer cover 120 in place over the sealed inner enclosure 110.

In some embodiments, the sealed inner enclosure 110 comprises a hermetically sealed casing. The sealed inner enclosure 110 provides a non-standard air environment for the components inside of the sealed data storage device 500A. For example, the sealed inner enclosure 110 may contain a lower-density gas, such as helium or hydrogen, such that the gaseous environment inside of the sealed inner enclosure 110 is a non-standard air environment. Sealing the sealed inner enclosure 110 prevents the lower-density gas(es) from escaping and contaminants from entering the sealed inner enclosure 110.

The sealed inner enclosure 110 and/or the outer cover 120 may include a valve that can be used during the manufacturing process to create the non-standard air environment inside of the sealed inner enclosure 110. FIG. 3C is a closer perspective view of the sealed data storage device 500A with a valve 116 exposed. In the illustrated example, the valve 116 extends through the outer cover 120 and into the interior of the sealed inner enclosure 110. The valve 116 can be used during the manufacturing process to fill the sealed inner enclosure 110 with an initial quantity of gas or mixture of gases (helium, hydrogen, oxygen, etc.). The valve 116 can be sealed during the manufacturing process to mitigate the deterioration of the non-standard air environment within the sealed inner enclosure 110.

FIG. 3D is a view of the sealed inner enclosure 110 of the sealed data storage device 500A. In other words, FIG. 3D is a view of the sealed data storage device 500A with the outer cover 120 removed. As shown, the sealed inner enclosure 110 includes an inner cover 111. The inner cover 111 includes a recessed region 112. When the outer cover 120 is in place, the space between the recessed region 112 and the outer cover 120 forms the gap 115 shown in FIG. 3A. The valve 116 extends through the inner cover 111.

The inventors named herein had the insight that the sealed data storage device 500A can be improved by compensating for the consumption of gas (a single gas or mixture of gases) as the sealed data storage device 500A operates. For example, passive compensation can be accomplished by including, between the sealed inner enclosure 110 and the outer cover 120, an environment-controlling substance that releases gas to replace gas being consumed as the sealed data storage device 500A operates. Likewise, passive reduction of humidity can be accomplished by including, between the sealed inner enclosure 110 and the outer cover 120, an environment-controlling substance that absorbs water as the sealed data storage device 500A operates.

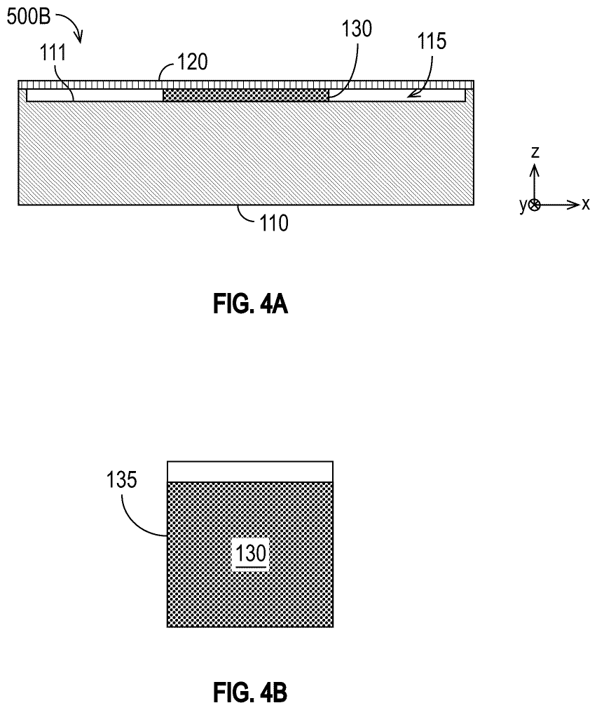

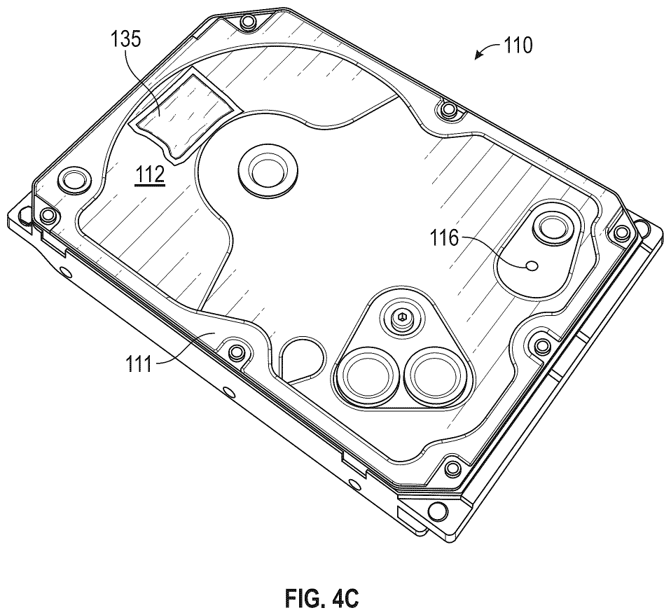

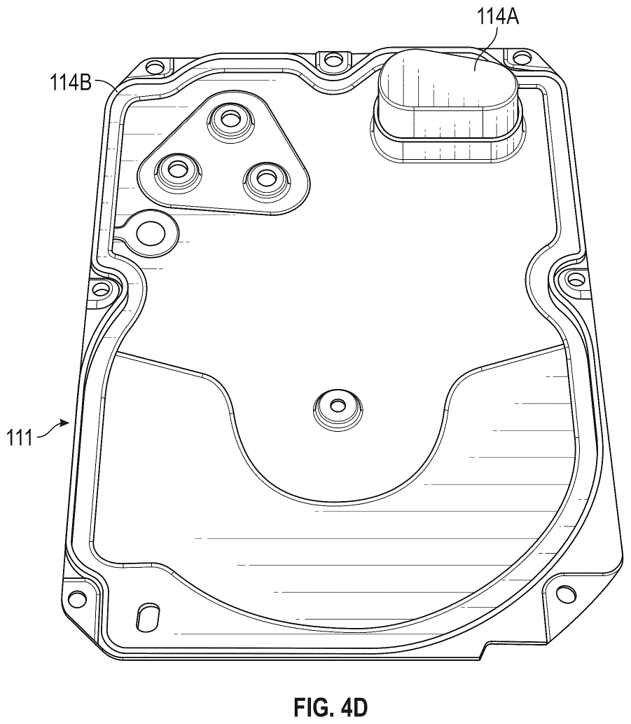

FIG. 4A is a representation of a sealed data storage device 500B that includes a sealed inner enclosure 110, an outer cover 120, and an environment-controlling substance 130 in the volume of space presented by the gap 115 between the inner cover 111 of the sealed inner enclosure 110 and the outer cover 120 in accordance with some embodiments. As explained further below, the environment-controlling substance 130 is situated in the gap 115 to provide, adjust, and/or control the environment within the interior of the sealed inner enclosure 110. The environment-controlling substance 130 can be situated in the gap 115 in any suitable manner.

When the environment-controlling substance 130 comprises an absorbing substance (e.g., to absorb excess water, to reduce humidity) it can comprise Zeolite, silica gel, or any other material that absorbs the desired gas or fluid (e.g., water vapor). The environment-controlling substance 130 can be situated in the gap 115 to absorb gas or fluid exiting the sealed inner enclosure 110.

Referring back to FIG. 2, the consumption of gas within a data storage device is temperature-dependent and pressure-dependent. Thus, when the environment-controlling substance 130 is provided to compensate for consumed gas within the sealed inner enclosure 110, the identity of the environment-controlling substance 130 (which material(s)) and the amount of the environment-controlling substance 130 included in the sealed data storage device 500B can be selected during the design process so that as the sealed data storage device 500B operates, and molecules of the gas originally present are consumed (e.g., for oxidation of smear), the consumed molecules are replaced by molecules of gas released by the environment-controlling substance 130. The identity and quantity of the environment-controlling substance 130 can be selected so that the release of gas under the expected temperature and pressure conditions substantially matches the consumption of gas. In other words, the gas-release profile of the environment-controlling substance 130 can be matched to the expected operating conditions so that the total amount of the gas inside of the sealed data storage device 500B remains substantially consistent, because consumed gas is being replenished at substantially the rate of consumption.

The environment-controlling substance 130 can be any substance that releases a gas that is to be replenished. For example, as explained further below, the environment-controlling substance 130 can be a compound that can release oxygen in response to heat or a metal-organic framework (MOF). The environment-controlling substance 130 releases gas over time, and the released gas can pass through a permeable membrane of the sealed inner enclosure 110 to replenish gas (e.g., oxygen) consumed by components of the sealed data storage device 500B inside of the sealed inner enclosure 110.

Compounds that can release oxygen in response to heat and that can be included in the environment-controlling substance 130 include, for example, permanganates (e.g., AgMnO₄, KMnO₄), peroxides (e.g., H₂O₂, CaO₂, MgO₂), perchlorates (e.g., KClO₃), perborates (e.g., NaBO₃.H₂O), persulfates (e.g., K₂S₂O₈), and percarbonates (e.g., Na₂CO₃·1.5H₂O₂). As will be understood by those having ordinary skill in the art, permanganate refers to the permanganate ion (MnO₄⁻) or compounds containing this ion. The permanganate ion is an anion with manganese in the +7 oxidation state. It is a strong oxidizing agent and can be used in various chemical and analytical applications. Potassium permanganate (KMnO₄) is an example of a common salt that contains the permanganate ion and can be used for its oxidizing properties. Potassium permanganate decomposes according to the formula 2KMnO₄→K₂MnO₄+MnO₂+O₂. Another example is AgMnO₄, which decomposes according to the formula 2AgMnO₄→Ag₂O+2MnO₂+1.5O₂.

As will also be understood by those having ordinary skill in the art, a peroxide is a chemical compound in which two oxygen atoms are linked together by a single covalent bond.

As will also be understood by those having ordinary skill in the art, perchlorate refers to the perchlorate ion (ClO₄⁻) or compounds containing this ion. The perchlorate ion is an anion with chlorine in the +7 oxidation state. Perchlorates are salts or esters derived from perchloric acid (HClO₄). An example of a perchlorate is KClO₃, which, with MnO₂, decomposes according to the formula 2KClO₃ (MnO₂)→2KCl+3O₂.

As will also be understood by those having ordinary skill in the art, perborate refers to the perborate ion (BO₄³⁻) or compounds containing this ion. Perborates are salts or esters derived from perboric acid (HBO₃). As will also be understood by those having ordinary skill in the art, a persulfate is a compound containing the anions SO₅^{2-¿¿} or S₂O₈^{2-¿¿}. Persulfate compounds include ammonium persulfate ((NH₄)₂S₂O₈), sodium persulfate (Na₂S₂O₈), and potassium persulfate (K₂S₂O₈). Persulfates have strong oxidizing properties. As will also be understood by those having ordinary skill in the art, percarbonate typically refers to the carbonate perhydrate anion (CO₃²⁻·H₂O₂), and compounds containing this anion. A compound associated with percarbonate is sodium percarbonate (2Na₂CO₃·3H₂O₂). The materials and compounds listed or described above may be suitable as the environment-controlling substance 130 when the gas being replaced is oxygen.

As another example, when the environment-controlling substance 130 is provided to add a gas to the environment of the sealed inner enclosure 110, the environment-controlling substance 130 can be (or comprise) a metal-organic framework (MOF). As will be understood by those having ordinary skill in the art, a MOF, which is sometimes also referred to as a porous coordination polymer, is a material that is composed of metal ions or clusters coordinated to organic molecules, forming a porous three-dimensional structure. In a MOF, metal ions or metal clusters (e.g., transition metals like zinc, copper, or aluminum) are connected by organic ligands that serve as linkers between the metal centers. The arrangement of metal ions and organic ligands creates a porous structure with a large internal surface area.

Because of the porous nature of MOFs, they can be used to capture certain molecules or atoms and release them in gaseous form. MOFs can thus be particularly efficient for storage of molecules or atoms that will help replenish gas depletion in certain environments. The porosity of a MOF can be adjusted by modifying the choice of metal ions and ligands, which allows the size and shape of the pores to be adjusted. The adsorption and desorption of gaseous molecules by a MOF can be a function of (e.g., controlled by) a variety of conditions/variables, such as, for example, one or more of temperature, pressure, and/or light. Examples of MOFs suitable for use with the techniques described herein include: Cd(bpndc)(4,4′-bpy), Co-BTTri, Co-BDTriP, Co-MOF-74, Co-MOF-74 Composite, Cr₃(BTC)₂, Cr-BTT, Cu(BDT), Cu(BDTri)L (L=DMF), Cu₃(BTC)₂, Cu-BTC, Cu-BTC Composite, Fe-MOF-74, Mg₃(NDC)₃, MIL-100 (Fe), MIL-100 (Sc), MIL-101 Composite, MOF-177, PCN-13, PCN-17, PCN-224FeII, UMCM-1, Zn(TCNQ-TCNQ)bpy, K1.09Fe₂(bdp)₃, K_{0.82}Fe₂(bdp)₃, K_{1.88}Fe₂(bdp)₃, K_{2.07}Fe₂(bpeb)₃, Ni-MOF-74, Ni₂(cyclam)₂(mtb), MIL-101 (Ti), Fe-BTTri, Cu(BDTri)L (L=DEF), Co₂Cl₂(BBTA), Co₂(OH)₂(BBTA), Mg-MOF-74, HKUST-1 (Hong Kong University of Science and Technology-1), UMCM-152 (ANUGIA), DIDDOK, XAWVUN&XEBHOC, COF-300, MIL-88C, NU-125, NU-1103, ZIF-8, and/or a zirconium-based MOF (e.g., UiO-66, NU-1000, etc.). It is to be appreciated that these MOFs are merely examples, and that this list of examples is not intended to be limiting or comprehensive.

A variety of techniques are known for charging a MOF, where charging is the process of introducing gas molecules (e.g., oxygen) into the MOF's porous structure or onto its surface. As will be appreciated by those having ordinary skill in the art, the specific method for charging a MOF can vary depending on the desired outcome and the MOF's properties. In some embodiments, after choosing and synthesizing a MOF (e.g., by mixing metal ions or clusters with organic ligands in a solvent under controlled conditions to promote MOF formation), guest molecules or solvents in the pores of the MOF that are used in the synthesis process can be removed by heating the MOF under vacuum or flowing an inert gas to remove the guest molecules. The MOF can then be exposed to the desired gas or vapor, such as, for example, by immersing the MOF in a sealed container with the gas (e.g., oxygen).

In some embodiments, the quantity of the environment-controlling substance 130 is selected to provide the amount of gas expected to be consumed by the sealed data storage device 500B over its lifetime, during its warranty period, or during any predetermined time period. For example, the environment-controlling substance 130 can release a quantity of gas that the sealed data storage device 500B is expected to consume over a particular number of years (3 years, 4, years, 5 years, 6 years, etc.). As a specific example, the environment-controlling substance 130 can release a quantity of gas that the sealed data storage device 500B is expected to consume over at least 5 years. As another example, the environment-controlling substance 130 can release a quantity of gas that the sealed data storage device 500B is expected to consume during a particular number of hours of operation.

The environment-controlling substance 130 can be in any suitable form. In some embodiments, the environment-controlling substance 130 is incorporated into a solid form that is configured to fit in the gap 115 between the sealed inner enclosure 110 and the outer cover 120. For example, the environment-controlling substance 130 can be in the form of a thin disk that fits in the gap 115. Processes to make such a solid form from the examples of the environment-controlling substance 130 provided above are known to those having ordinary skill in the art. For example, the environment-controlling substance 130 can be incorporated into a solid form by (a) combining a powder form of the environment-controlling substance 130 with excipients such as binders (e.g., microcrystalline cellulose), disintegrants, and lubricants (e.g., magnesium stearate); (b) blending to produce a homogenous blend of all components; and (c) compressing the blend into a form of the desired size and shape. Optionally, coating the form with a protective layer can be used to help control the gas release rate when the environment-controlling substance 130 is a gas-releasing substance. For example, a coating solution can be prepared using water-soluble or water-insoluble polymers (e.g., ethyl cellulose, hydroxypropyl methylcellulose), and a coating pan can be used to apply the coating to the solid form.

In some embodiments, the environment-controlling substance 130 is in a paste form, and the paste is situated in the gap 115 (e.g., spread over the recessed region 112 of the inner cover 111 described below or applied to the underside of the outer cover 120). Processes to make such a paste form from the examples of the environment-controlling substance 130 provided above are known to those having ordinary skill in the art. For example, the environment-controlling substance 130 can be incorporated into a paste form by (a) dissolving a thickening agent (e.g., xanthan gum, cellulose derivatives such as hydroxyethyl cellulose (HEC), or synthetic polymers like polyvinyl alcohol (PVA)) in water or an aqueous solution; (b) allowing the solution to hydrate and thicken to the desired consistency; (c) optionally adding stabilizers (e.g., sodium silicate, sodium carbonate) and/or surfactants (e.g., non-ionic surfactants such as alkyl polyglucosides) and/or preservatives (e.g., to prevent microbial growth) to the thickened solution and mixing thoroughly to ensure that these additives are fully dissolved and uniformly distributed; (d) adding a powder form of the environment-controlling substance 130 to the thickened solution (e.g., while stirring continuously to ensure even dispersion); (e) adjusting the consistency (e.g., if the paste is too thick, adding small amounts of water or aqueous solution, and if the paste is too thin, adding more thickening agent solution); and (f) using a homogenizer or high-shear mixer to achieve a smooth and homogeneous paste.

In some embodiments, the environment-controlling substance 130 is included in the sealed data storage device in a powder form, and it is held by a container. For example, the environment-controlling substance 130 can be in powder form and situated in a permeable container that fits in the gap 115. FIG. 4B is a representation of a permeable container 135 that contains an environment-controlling substance 130 in accordance with some embodiments. The permeable container 135 can be made of a single material, or it can comprise multiple materials. In some embodiments, the permeable container 135 is selective, meaning that it selectively permits certain substances (e.g., gases, vapors) to pass but blocks others (e.g., solids).

In some embodiments, some or all of the permeable container 135 is malleable as well as permeable. In other words, in some embodiments, the permeable container 135 allows gas to diffuse out of, or a substance (e.g., gas, vapor) to enter, the permeable container 135 and is also flexible and adaptable to different shapes, allowing the permeable container 135 to be shaped or manipulated without breaking. It is desirable that the permeable container 135 be durable so that it can resist mechanical stress and environmental factors such as temperature and humidity. It is also desirable for the permeable container 135 to be able to withstand pressures that can be applied to it when, during the manufacturing process, the non-standard air environment is created in the sealed inner enclosure 110. During this process, the gap 115, and therefore the permeable container 135 situated in the gap 115, can be compressed.

Nanotechnology can be used to create some or all of the permeable container 135 to have precise pore sizes and a desired performance. In some embodiments, the permeable container 135 includes a smart membrane (e.g., a stimulus-responsive membrane) that can respond to environmental changes, such as temperature, to provide dynamic regulation of the permeability of the permeable container 135. As an example, the permeable container 135 can comprise a temperature-responsive membrane made from one or more polymers that expand or contract with temperature changes.

In some embodiments, the permeable container 135 comprises at least one of polyethylene (PE), polypropylene (PP), polyurethane (PU), ethylene vinyl acetate (EVA), polytetrafluoroethylene (PTFE), polyamide (PA), polyimide, polyvinyl alcohol (PVA), polyvinyl chloride (PVC), polyacrylonitrile (PAN), polyethylene terephthalate (PET), cellulose acetate, polysulfone (PSU), or polyvinylidene fluoride (PVDF).

FIG. 4C is an illustration of the example of a sealed inner enclosure 110 with a permeable container 135 that contains an environment-controlling substance 130 situated in the recessed region 112 of the inner cover 111. In the illustrated example, the permeable container 135 comprises PTFE. It is to be appreciated that the permeable container 135, if used, can be made from other materials as discussed above.

FIG. 4D is a view of the underside of the inner cover 111 in accordance with some embodiments. The inner cover 111 includes at least one permeable membrane that, in some embodiments, allows gas released by an environment-controlling substance situated in the gap 115 to pass into the interior of the sealed inner enclosure 110. In some embodiments, the at least one permeable membrane of the inner cover 111 allows at least one substance (e.g., water vapor) to exit the interior of the sealed inner enclosure 110. In the example of FIG. 4D, the inner cover 111 has a permeable membrane 114A near/under the valve 116 (see FIG. 4C) and a permeable membrane 114B that extends around the inner cover 111. The permeable membrane 114B may be, for example, a formed-in-place gasket (FIPG) or a cured-in-place gasket (CIPG) configured to provide a seal when the inner cover 111 is in place with the rest of the sealed inner enclosure 110. As will be appreciated, an FIPG or CIPG can take the form of a solid bead of an elastomer material that is disposed generally about a periphery of the inner cover 111. The material making up the permeable membrane 114B may be dispensed upon the inner cover 111 in a liquid form that can be subsequently cured. The permeable membrane 114B can be compressed in order to achieve an adequate seal. The permeable membrane 114B helps to maintain the non-standard air environment inside of the sealed inner enclosure 110.

The permeable membrane 114A and permeable membrane 114B are two paths that can allow gas released by an environment-controlling substance 130 situated in the gap 115 to enter the sealed inner enclosure 110 (e.g., when the sealed data storage device 500B is in operation) and/or to allow a substance (e.g., water) inside of the sealed inner enclosure 110 to escape. In other words, the sealed inner enclosure 110 comprises at least one membrane (e.g., the permeable membrane 114A and/or the permeable membrane 114B) that allows the environment-controlling substance 130 to affect the gaseous environment inside of the sealed inner enclosure 110 (by allowing a gas released by the environment-controlling substance 130 to enter the sealed inner enclosure 110, by allowing water vapor inside of the sealed inner enclosure 110 to exit the sealed inner enclosure 110 and be absorbed by the environment-controlling substance 130, etc.). It is to be appreciated that an implementation could include only one of the permeable membrane 114A or the permeable membrane 114B. Similarly, an implementation could include one or more different paths to and/or from the environment-controlling substance 130 either in addition to or instead of one or both of the permeable membrane 114A or the permeable membrane 114B. In general, a single path between the environment-controlling substance 130 in the gap 115 and the interior of the sealed inner enclosure 110 is sufficient to allow the environment-controlling substance 130 to affect the gaseous environment inside of the sealed inner enclosure 110.

The permeable membrane 114A and/or permeable membrane 114B can be made from any suitable material. For example, the permeable membrane 114A and/or permeable membrane 114B can comprise PE, PP, PU, EVA, PTFE, PA, polyimide, PVA, PVC, PAN, PET, cellulose acetate, PSU, PVDF, GoreTex, or similar materials.

It is to be appreciated that the sealed inner enclosure 110 can include any feature or combination of features and/or use any technique or combination of techniques that provide an appropriate path between the environment-controlling substance 130 and the sealed inner enclosure 110. For example, the sealed inner enclosure 110 can include membrane materials that have selective permeability properties to allow certain gases to pass into the sealed inner enclosure 110 while blocking others or to allow passage under specific conditions (e.g., a chemical coating can be applied to filter paper to create a layer that selectively allows gas to pass in one direction). As another example, the sealed inner enclosure 110 can include membrane materials that allow a substance (e.g., water vapor) to exit the sealed inner enclosure 110 but not enter it. As another example, the sealed inner enclosure 110 can include a one-way valve designed to open under certain pressure conditions, allowing gas to enter but not to exit the sealed inner enclosure 110. The sealed inner enclosure 110 could also use a check valve in conjunction with filter paper to allow gas released by the environment-controlling substance 130 to flow from the gap 115 into the sealed inner enclosure 110. As yet another example, the sealed inner enclosure 110 can include a diaphragm mechanism in which a flexible membrane moves to allow gas in and seals to prevent it from exiting, or a flapper valve that opens with the pressure of incoming gas and closes to prevent backflow. Similar features can be included to allow the release of excess moisture from the sealed inner enclosure 110.

Thus, as explained in detail above, on some embodiments, a data storage device 500 includes a sealed inner enclosure 110, wherein a gaseous environment inside of the sealed inner enclosure 110 differs from a standard air environment, an outer cover 120 situated over and coupled to at least a portion of the sealed inner enclosure 110, and means for providing an environment-controlling substance 130 between the sealed inner enclosure 110 and the outer cover 120. The means for providing the environment-controlling substance 130 can be, for example, a permeable container 135, a paste, or a solid form, as explained above.

As also explained above, in some embodiments, the sealed inner enclosure 110 includes means for allowing the environment-controlling substance 130 to affect the gaseous environment inside of the sealed inner enclosure 110. The means for allowing the environment-controlling substance 130 to affect the gaseous environment inside of the sealed inner enclosure 110 can include, for example, a permeable membrane of the sealed inner enclosure 110 (e.g., the permeable membrane 114A and/or permeable membrane 114B).

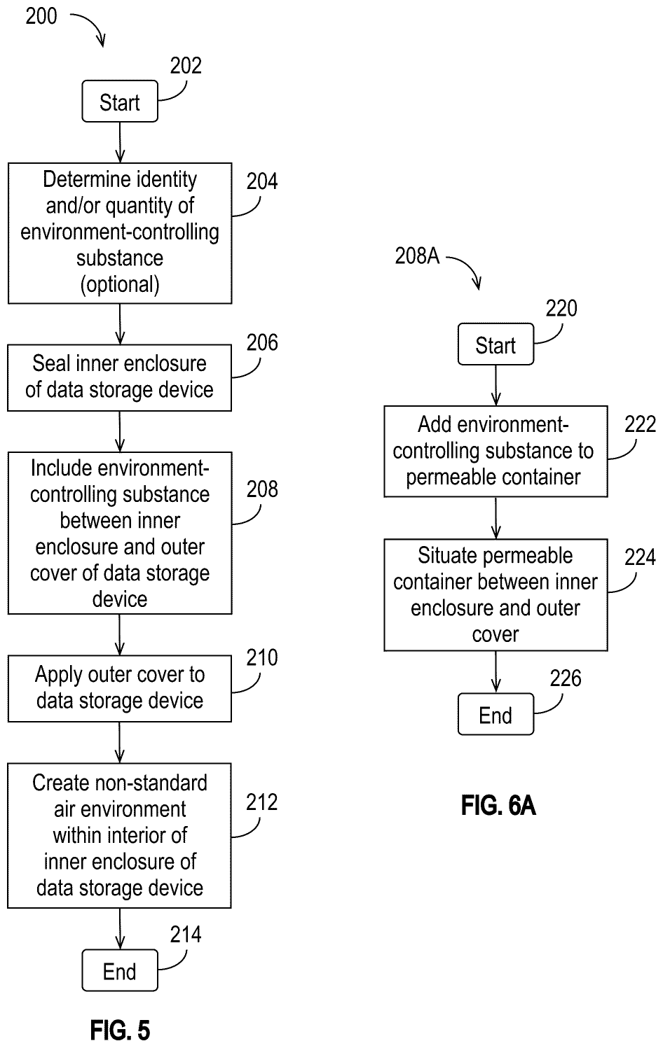

FIG. 5 is a flow diagram of a method 200 of manufacturing a sealed data storage device 500B in accordance with some embodiments. At block 202, the method 200 begins. At block 204, optionally, an environment-controlling substance 130 is selected and/or a quantity of the environment-controlling substance 130 to be included in the sealed data storage device 500B is determined as described above. For example, the environment-controlling substance 130 can be a metal-organic framework (MOF) or a compound that can release oxygen in response to heat (a permanganate (e.g., AgMnO₄, KMnO₄), a peroxide (e.g., H₂O₂, CaO₂, MgO₂), a perchlorate (e.g., KClO₃), a perborate (e.g., NaBO₃.H₂O), a persulfate (e.g., K₂S₂O₈), a percarbonate (e.g., Na₂CO₃·1.5H₂O₂), etc.). As another example, the environment-controlling substance 130 can be a material that provides humidity control (Zeolite, silica gel, etc.). The quantity can be computed in any suitable way, such as, for example, based on the identity of the selected environment-controlling substance 130 and the expected amount of gas to be consumed by and/or the expected absorption capability needed for the sealed data storage device 500B during a time period (its lifetime, a warranty period, etc.). The quantity of the environment-controlling substance 130 can be selected to compensate for the amount of gas expected to be consumed and/or the expected absorption capability.

At block 206, the sealed inner enclosure 110 of the sealed data storage device 500B is sealed. For example, as described above, an inner cover 111 having a permeable membrane 114B can be put into place over a main body of the sealed inner enclosure 110.

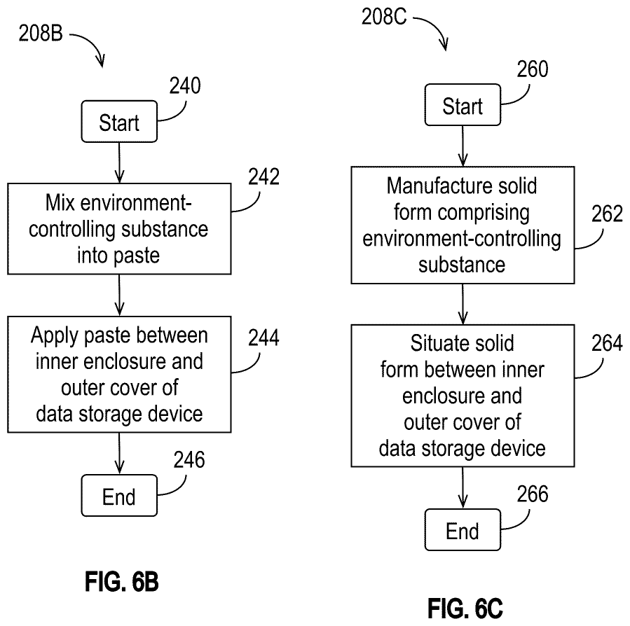

At block 208, the environment-controlling substance 130 is included (situated) between the sealed inner enclosure 110 and the outer cover 120 using any suitable approach, as described elsewhere herein. Three example approaches are described below in the context of FIGS. 6A, 6B, and 6C.

At block 210, the outer cover 120 is applied to the sealed data storage device 500B (e.g., situated over the sealed inner enclosure 110 as explained above).

At block 212, a non-standard air environment is created within the interior of the sealed inner enclosure 110. For example, as described above, a valve 116 can be used to vacuum out the standard air within the enclosure, and a non-standard air environment can be created (e.g., by injecting helium and/or other gas(es)). The performance of block 212 can also affect the gap 115 and any contents of the gap 115 (a permeable container 135, a paste comprising the environment-controlling substance 130, a solid form comprising the environment-controlling substance 130, etc.).

At block 214, the method 200 ends.

It is to be appreciated that the steps of the method 200 can be performed in a different order than shown.

As stated above, the environment-controlling substance 130 can be included (situated) between the sealed inner enclosure 110 and the outer cover 120 using any suitable approach. FIG. 6A is a flow diagram of an example of a method 208A that can be used to perform block 208 of FIG. 5 in accordance with some embodiments. The method 208A can be performed when the environment-controlling substance 130 is contained in a permeable container 135 situated in the gap 115 between the sealed inner enclosure 110 and the outer cover 120.

At block 220, the method 208A begins. At block 222, an environment-controlling substance 130 is added to a permeable container 135. As explained previously, the permeable container 135 can be made of any suitable material (e.g., at least one of polydimethylsiloxane (PDMS), polyethylene (PE), polypropylene (PP), polyurethane (PU), ethylene vinyl acetate (EVA), polytetrafluoroethylene (PTFE), silicone rubber, cellulose acetate, polysulfone (PSU), or polyvinylidene fluoride (PVDF)).

At block 224, the permeable container 135 is situated between the sealed inner enclosure 110 and the outer cover 120. For example, the permeable container 135 can be positioned in the recessed region 112 of an inner cover 111 of the sealed inner enclosure 110 before the outer cover 120 is put into place.

At block 226, the method 208A ends.

FIG. 6B is a flow diagram of an example of a method 208B that can be used to perform block 208 of FIG. 5 in accordance with some embodiments. The method 208B can be performed when the environment-controlling substance 130 is included in a paste applied in the gap 115 between the sealed inner enclosure 110 and the outer cover 120. At block 240, the method 208B begins.

At block 242, the environment-controlling substance 130 is mixed into a paste using any suitable technique. For example, as described above, the environment-controlling substance 130 can be incorporated into a paste form by (a) dissolving a thickening agent (e.g., xanthan gum, cellulose derivatives such as hydroxyethyl cellulose (HEC), or synthetic polymers like polyvinyl alcohol (PVA)) in water or an aqueous solution; (b) allowing the solution to hydrate and thicken to the desired consistency; (c) optionally adding stabilizers (e.g., sodium silicate, sodium carbonate) and/or surfactants (e.g., non-ionic surfactants such as alkyl polyglucosides) and/or preservatives (e.g., to prevent microbial growth) to the thickened solution and mixing thoroughly to ensure that these additives are fully dissolved and uniformly distributed; (d) adding a powder form of the environment-controlling substance 130 to the thickened solution (e.g., while stirring continuously to ensure even dispersion); (e) adjusting the consistency (e.g., if the paste is too thick, adding small amounts of water or aqueous solution, and if the paste is too thin, adding more thickening agent solution); and (f) using a homogenizer or high-shear mixer to achieve a smooth and homogeneous paste.

At block 244, the paste is applied in the gap 115 between the sealed inner enclosure 110 and the outer cover 120. The paste can be applied in any suitable manner (e.g., squeezing, brushing, etc.).

At block 246, the method 208B ends.

FIG. 6C is a flow diagram of an example of a method 208C that can be used to perform block 208 of FIG. 5 in accordance with some embodiments. The method 208C can be performed when the environment-controlling substance 130 is included in a solid form that is situated in the gap 115 between the sealed inner enclosure 110 and the outer cover 120. At block 260, the method 208C begins.

At block 262, a solid form that comprises the environment-controlling substance 130 is manufactured. The solid form can be created using any suitable technique. For example, as described above, the environment-controlling substance 130 can be incorporated into a solid form (e.g., a disk) by (a) combining a powder form of the environment-controlling substance 130 with excipients such as binders (e.g., microcrystalline cellulose), disintegrants, and lubricants (e.g., magnesium stearate); (b) blending to produce a homogenous blend of all components; and (c) compressing the blend into a form of the desired size and shape. Optionally, coating the form with a protective layer can be used to help control the gas release rate. For example, a coating solution can be prepared using water-soluble or water-insoluble polymers (e.g., ethyl cellulose, hydroxypropyl methylcellulose), and a coating pan can be used to apply the coating to the solid form.

At block 264, the solid form is situated in the gap 115 between the sealed inner enclosure 110 and the outer cover 120. For example, the solid form can be positioned in the recessed region 112 of an inner cover 111 of the sealed inner enclosure 110 before the outer cover 120 is put into place.

At block 266, the method 208C ends.

The efficacy of the techniques disclosed herein was verified in lab tests. In the tests, the environment-controlling substance 130 was sodium percarbonate (2Na₂CO₃·3H₂O₂) to release oxygen, and a permeable container 135 in the form of a PTFE bag having a thickness of 0.3-0.6 mm when full was used as the permeable container 135 situated in the gap 115 between the sealed inner enclosure 110 and the outer cover 120. The spindle motor current (or power associated with that current) used to rotate the recording medium 516 at a specified angular speed can be used as a proxy for the oxygen content within the sealed data storage device 500B. Specifically, when the current is higher, more oxygen is present, and when the current is lower, less oxygen is present. It was confirmed that the spindle motor current is higher when the permeable container 135 containing the environment-controlling substance 130 is included between the sealed inner enclosure 110 and the outer cover 120 than when it is not. Therefore, the inclusion of an environment-controlling substance 130 in the gap 115 between the sealed inner enclosure 110 and the outer cover 120 was shown to be effective for increasing the oxygen inside of the sealed inner enclosure 110.

In the foregoing description and in the accompanying drawings, specific terminology has been set forth to provide a thorough understanding of the disclosed embodiments. In some instances, the terminology or drawings may imply specific details that are not required to practice the invention.

To avoid obscuring the present disclosure unnecessarily, well-known components are shown in block diagram form and/or are not discussed in detail or, in some cases, at all.

Unless otherwise specifically defined herein, all terms are to be given their broadest possible interpretation, including meanings implied from the specification and drawings and meanings understood by those skilled in the art and/or as defined in dictionaries, treatises, etc. As set forth explicitly herein, some terms may not comport with their ordinary or customary meanings.

As used in the specification and the appended claims, the singular forms “a,” “an” and “the” do not exclude plural referents unless otherwise specified. The word “or” is to be interpreted as inclusive unless otherwise specified. Thus, the phrase “A or B” is to be interpreted as meaning all of the following: “both A and B,” “A but not B,” and “B but not A.” Any use of “and/or” herein does not mean that the word “or” alone connotes exclusivity.

As used in the specification and the appended claims, phrases of the form “at least one of A, B, and C,” “at least one of A, B, or C,” “one or more of A, B, or C,” and “one or more of A, B, and C” are interchangeable, and each encompasses all of the following meanings: “A only,” “B only,” “C only,” “A and B but not C,” “A and C but not B,” “B and C but not A,” and “all of A, B, and C.”

To the extent that the terms “include(s),” “having,” “has,” “with,” and variants thereof are used in the detailed description or the claims, such terms are intended to be inclusive in a manner similar to the term “comprising,” i.e., meaning “including but not limited to.”

The terms “exemplary” and “embodiment” are used to express examples, not preferences or requirements.

The term “coupled” is used herein to express a direct connection/attachment as well as a connection/attachment through one or more intervening elements or structures.

The terms “over,” “under,” “between,” and “on” are used herein to refer to a relative position of one feature with respect to other features. For example, one feature disposed “over” or “under” another feature may be directly in contact with the other feature or may have intervening material. Moreover, one feature disposed “between” two features may be directly in contact with the two features or may have one or more intervening features or materials. In contrast, a first feature “on” a second feature is in contact with that second feature.

The term “substantially” is used to describe a structure, configuration, dimension, etc. that is largely or nearly as stated, but, due to manufacturing tolerances and the like, may in practice result in a situation in which the structure, configuration, dimension, etc. is not always or necessarily precisely as stated. For example, describing two lengths as “substantially equal” means that the two lengths are the same for all practical purposes, but they may not (and need not) be precisely equal at sufficiently small scales. As another example, a structure that is “substantially vertical” would be considered to be vertical for all practical purposes, even if it is not precisely at 90 degrees relative to horizontal.

The drawings are not necessarily to scale, and the dimensions, shapes, and sizes of the features may differ substantially from how they are depicted in the drawings.

Although specific embodiments have been disclosed, it will be evident that various modifications and changes may be made thereto without departing from the broader spirit and scope of the disclosure. For example, features or aspects of any of the embodiments may be applied, at least where practicable, in combination with any other of the embodiments or in place of counterpart features or aspects thereof. Accordingly, the specification and drawings are to be regarded in an illustrative rather than a restrictive sense.

1. A data storage device, comprising:
a sealed inner enclosure, wherein a gaseous environment inside of the sealed inner enclosure differs from a standard air environment;
an outer cover situated over and coupled to at least a portion of the sealed inner enclosure; and
an environment-controlling substance situated between the sealed inner enclosure and the outer cover,
wherein the sealed inner enclosure comprises at least one membrane to allow the environment-controlling substance to affect the gaseous environment inside of the sealed inner enclosure.

2. The data storage device recited in claim 1, wherein the environment-controlling substance comprises a gas-releasing substance configured to release a gas.

3. The data storage device recited in claim 2, wherein the gas-releasing substance comprises at least one of: a metal-organic framework (MOF), a chemical compound, KMnO₄, KClO₃, MnO₂, AgMnO₄, Na₂CO₃·1.5H₂O₂, Cu-BTC, or MIL 101 composite.

4. The data storage device recited in claim 1, wherein the environment-controlling substance comprises a water-absorbing substance.

5. The data storage device recited in claim 4, wherein the water-absorbing substance comprises Zeolite or silica gel.

6. The data storage device recited in claim 1, wherein the environment-controlling substance is in a powder form, and further comprising a permeable container, wherein the environment-controlling substance is situated inside of the permeable container.

7. The data storage device recited in claim 6, wherein at least a portion of the permeable container is malleable.

8. The data storage device recited in claim 6, wherein the permeable container comprises at least one of polydimethylsiloxane (PDMS), polyethylene (PE), polypropylene (PP), polyurethane (PU), ethylene vinyl acetate (EVA), polytetrafluoroethylene (PTFE), silicone rubber, cellulose acetate, polysulfone (PSU), or polyvinylidene fluoride (PVDF).

9. The data storage device recited in claim 1, wherein the environment-controlling substance is included in: (a) a solid form situated in a volume of space between the sealed inner enclosure and the outer cover, or (b) a paste situated between the sealed inner enclosure and the outer cover.

10. The data storage device recited in claim 1, wherein a quantity of the environment-controlling substance is sufficient to:
release an amount of a gas expected to be consumed during a period of operation of the data storage device, and/or
absorb an expected amount of excess humidity during a period of operation of the data storage device.

11. The data storage device recited in claim 10, wherein the period of operation is a warranty period, an expected lifetime, or a specified number of hours.

12. A method of manufacturing a data storage device, the method comprising:
sealing an inner enclosure of the data storage device;
applying an outer cover to the data storage device;
including an environment-controlling substance between the inner enclosure of the data storage device and the outer cover of the data storage device; and
creating a non-standard air environment within an interior of the inner enclosure of the data storage device.

13. The method of claim 12, wherein including the environment-controlling substance between the inner enclosure of the data storage device and the outer cover comprises situating a permeable container between the inner enclosure of the data storage device and the outer cover, wherein the permeable container contains the environment-controlling substance.

14. The method of claim 13, wherein at least a portion of the permeable container is malleable.

15. The method of claim 13, wherein the permeable container comprises at least one of polydimethylsiloxane (PDMS), polyethylene (PE), polypropylene (PP), polyurethane (PU), ethylene vinyl acetate (EVA), polytetrafluoroethylene (PTFE), silicone rubber, cellulose acetate, polysulfone (PSU), or polyvinylidene fluoride (PVDF).

16. The method of claim 12, wherein including the environment-controlling substance between the inner enclosure of the data storage device and the outer cover comprises at least one of:
applying a paste between the inner enclosure of the data storage device and the outer cover, wherein the paste comprises the environment-controlling substance, or
situating a solid form between the inner enclosure of the data storage device and the outer cover, wherein the solid form comprises the environment-controlling substance.

17. The method of claim 12, wherein:
including the environment-controlling substance between the inner enclosure of the data storage device and the outer cover comprises placing a container, a paste, or a solid form containing the environment-controlling substance in contact with the inner enclosure of the data storage device, and
applying the outer cover to the data storage device comprises attaching the outer cover to the inner enclosure of the data storage device after placing the container, the paste, or the solid form containing the environment-controlling substance in contact with the inner enclosure of the data storage device.

18. The method of claim 12, wherein the environment-controlling substance comprises a metal-organic framework (MOF), a chemical compound, or a water-absorbing substance.

19. The method of claim 18, wherein the environment-controlling substance comprises at least one of: KMnO₄, KClO₃, MnO₂, AgMnO₄, Na₂CO₃·1.5H₂O₂, Cu-BTC, MIL 101 composite, Zeolite, or silica gel.

20. A data storage device, comprising:
a sealed inner enclosure, wherein a gaseous environment inside of the sealed inner enclosure differs from a standard air environment;
an outer cover situated over and coupled to at least a portion of the sealed inner enclosure; and
means for providing an environment-controlling substance between the sealed inner enclosure and the outer cover,
wherein the sealed inner enclosure comprises means for allowing the environment-controlling substance to affect the gaseous environment inside of the sealed inner enclosure.
